(19) United States
(12) Patent Application Publication
(10) Pub. No.: US 2009/0008483 A1
(43) Pub. Date: Jan. 8, 2009

(54) Fuel injector for an internal combustion engine

(76) Inventor: Gregor Renner, Stuttgart (DE)

Correspondence Address: KLAUS J. BACH, 4407 TWIN OAKS DRIVE, MURRYSVILLE, PA, 15668, US

(21) Appl. No.: 12/150,348

(22) Filed: Apr. 25, 2008

Related U.S. Application Data
(63) Continuation-in-part of application No. PCT/EP2006/009753, filed on Oct. 10, 2006.

(30) Foreign Application Priority Data
Oct. 27, 2005 (DE) 10 2005 051 438.3

(51) Int. Cl. F02M 51/00

(52) U.S. Cl. 239/585.1

(57) ABSTRACT

In a fuel injector for an internal combustion engine comprising an injector housing including a valve element as well as a number of piezo-crystals stacked on top of one another for actuating the valve element, wherein the stack of piezo-crystals is supported by a carrier element which is disposed in a cavity of the injector housing in spaced relationship therefrom, a first seal is provided in a gap between the housing and the carrier element to close a fuel space in a sealed fashion and a further sealing element is located at a distance from the first seal in the gap so that a cavity is formed between the first seal and the sealing element for collecting fuel possibly leaking through the first seal.

This is a Continuation-in-Part application of pending international patent application PCT/EP2006/009753 filed Oct. 10, 2006 and claiming the priority of German patent application 10 2005 051 438.3 filed Oct. 27, 2005.

### BACKGROUND OF THE INVENTION

The invention relates to a fuel injector for an internal combustion engine having an injector housing, a valve element and a stack of piezo-crystals for actuating the valve element.

In order to energize the piezo-crystals, electrical lines are connected to electrodes on the piezo-crystals. These lines are accommodated in a component which at the same time serves to secure the stack of piezoelements. An electrical plug-in contact to which the lines are connected is provided on the injector housing. Since the stack of piezo-crystals is usually located in a fuel space which is subjected to high pressure, measures for sealing the fuel space to prevent fuel from escaping have to be taken, in particular at the electrical plug-in contact.

It is the principal object of the present invention to provide a fuel injector in which fuel is easily and reliably prevented from escaping from the injector housing into the region of the electrical connections of the fuel injector.

### SUMMARY OF THE INVENTION

In a fuel injector for an internal combustion engine comprising an injector housing including a valve element as well as a number of piezo-crystals stacked on top of one another for actuating the valve element, wherein the stack of piezo-crystals is supported by a carrier element which is disposed in a cavity of the injector housing in spaced relationship therefrom, a first seal is provided in a gap between the housing and the carrier element to close a fuel space in a sealed fashion and a further sealing element is located at a distance from the first seal in the gap so that a cavity is formed between the first seal and the sealing element for collecting fuel possibly leaking through the first seal.

The arrangement of two sealing points, specifically the first seal adjacent to the fuel space and the further seal at a distance therefrom makes it possible to form a cavity for accommodating fuel which possibly escapes from the fuel space near the carrier element. This small quantity of fuel is carried away from the cavity by selective leakage in specific operating states or by being released so that pressure does not build up in the cavity. This ensures that fuel cannot reach the outside through the further sealing element and find its way to the plug-in contact which is arranged on the injector housing.

According to a further embodiment of the invention, the first seal is formed by virtue of the fact that the carrier element has a sealing surface which can be pressed against a sealing seat which is formed on the injector housing. In this way, the two components form a seal by bearing one against the other without an additional sealing means being necessary at this point. It is particularly suitable here that both the sealing surface and the sealing seat are of spherical design, while the sealing surface is convex and the sealing seat is concave.

The carrier element has a neck which extends through a wall of the injector housing. Electrical connecting lines for energizing the piezocrystals are accommodated in the neck and a plug-in contact is provided at the outer end of the neck. In this way, the electrical lines are held securely and the carrier element can easily be attached in the injector housing. In this context, a certain dimensional distance between the neck and a bore, which accommodates the latter, in the injector housing is not only advantageous for easier insertion when mounting but also has the effect of forming an annular gap which acts as a cavity between the first seal and the further seal.

The carrier element can be embodied in two parts and is composed here of an inner element, which forms the neck, and of a concentric annular element, on which the sealing surface is formed. According to one advantageous embodiment, the sealing surface can be lifted off from the sealing seat when the internal combustion engine is shut down so that an intentional leak is formed in order to carry back into the fuel space any fuel which has possibly entered the cavity or at least to lower the pressure to the ambient pressure level. This occurs via gap leaks in the fuel circuit while the engine is shut down. Before the engine is started and also before fuel pressure is generated, the sealing surface is pressed again against the sealing seat by virtue of the fact that the piezoelements are energized whereby the stack expands and presses the annular element in the region of the seal against the injector housing with a large sealing force.

As an alternative to the first seal which is formed from a sealing surface and a sealing seat, a seal which is formed in a different way can also be provided, for example a ring made of plastic or rubber. In this case, the cavity which is formed in the annular gap can be vented via a fuel leakage line which is not pressurized and preferably extends into the fuel tank.

The invention will become more readily apparent from the following description of an exemplary embodiment thereof with reference to the accompanying drawings:

### BRIEF DESCRIPTION OF THE DRAWINGS

FIG. 1 shows in a longitudinal sectional view a fuel injector, and

FIG. 2 is an enlarged illustration of the detail II in FIG. 1.

### DESCRIPTION OF AN EXEMPLARY EMBODIMENT

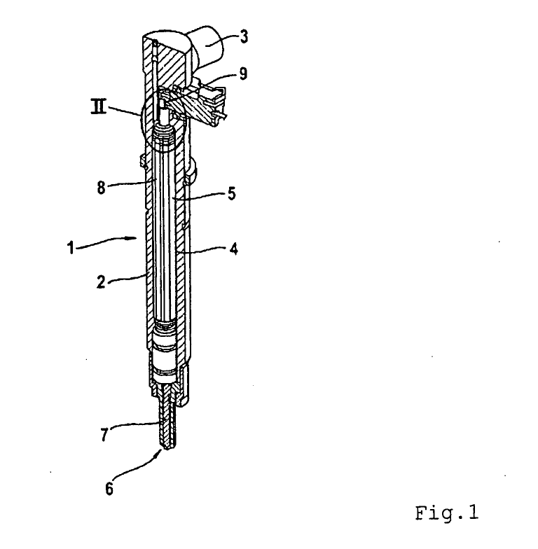

FIG. 1 illustrates a fuel injector 1 in a longitudinal sectional view, wherein a fuel inlet 3 is provided on an injector housing 2 at the upper end thereof. This fuel inlet 3 is in communication with a fuel space 4. At the lower end of the injector housing 2, an injection valve 6 is arranged including a valve element 7. In order to actuate the valve element 7, a stack of piezocrystals 5 is arranged in the fuel space 4, and electrical leads 8 extend along the stack of piezo-crystals for energizing the piezo-crystals. A plug-in contact structure 9 for connecting the electrical leads 8 is also provided near the upper end of the injector housing 2.

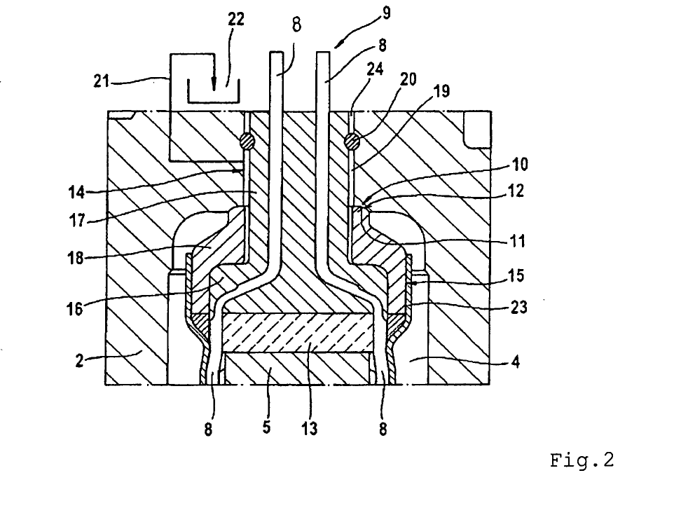

FIG. 2 shows the detail II from FIG. 1 in an enlarged illustration. The fuel space 4, in the center of which the stack of piezocrystals 5 is arranged, is formed in the injector housing 2. The stack of piezocrystals 5 is held by a carrier element 15 which is accommodated in a bore 14 in the injector housing 2. In the illustrated example of the embodiment, the carrier element 15 is composed of two components, namely an inner element 16 with a neck 17 and an annular element 18 which is arranged concentrically with respect thereto. The neck 17 is mounted in the bore 14 in the injector housing 2. The electrical connecting lines 8, which lead to the plug-in contact 9 on the one hand and to the stack of piezocrystals 5 on the other, extend in the neck 17. The stack of piezoelements 5 is supported with respect to the carrier element 15 by means of a supporting plate 13 made of a dimensionally stable material. In order to prevent fuel from penetrating as far as the stack of piezocrystals 5, a shrinkable hose 23 is provided which surrounds the carrier element 15 and the stack of piezocrystals 5 with the connecting lines 8 in a seal-forming fashion.

A first seal 10 is provided between the carrier element 15 and the injector housing 2, said seal 10 being composed in the exemplary embodiment of a sealing surface 11 on the annular element 18 and of a sealing seat 12 on the injector housing 2. Both the sealing surface 11 and the sealing seat 12 are of spherical design, with the sealing seat 12 being concave and the sealing surface 11 being convex. Because of the dimensional difference between the inner wall of the bore 14 and the outer circumference of the neck 17, an annular gap 24 is provided in which a further sealing element 20 in the form of a sealing ring is arranged at a distance from the first seal 10. In this way, a cavity 19 which is sealed both with respect to the fuel space 4 and with respect to the outside of the injector housing 2 is formed between the first seal 10 and the further sealing element 20, in the annular gap 24. In the exemplary embodiment in FIG. 2, a fuel leakage line 21, which extends to a fuel tank 22, is connected to the annular gap 24 in the region of the cavity 19. In this way, the cavity 19 is subjected only to ambient pressure, i.e. fuel which possibly gets into the cavity 19 from the fuel space 4 through the first seal 10 is carried away via the fuel leakage line 21.

As an alternative to the fuel leakage line 21, fuel which possibly collects in the cavity 19 can be carried away by virtue of the fact that, when the internal combustion engine is shut down, an intentional leak is occurs at the first seal 10. In this context it is assumed that, when the internal combustion engine is shut down, the pressure in the fuel space 4 decreases and the sealing surface 11 lifts off from the sealing seat 12 as a result of the stack of piezocrystals being deenergized, so that fuel which is collected in the cavity 19 is discharged into the fuel space 4 or at least the pressure level is lowered to ambient pressure. Before startup of the internal combustion engine and before the pressure builds up in the fuel system, the stack of piezocrystals 5 must then be energized so that the sealing surface 11 is firmly pressed against the sealing seat 12 and the first seal 10 is therefore provided with its sealing function.

What is claimed is:

1. A fuel injector (1) for an internal combustion engine comprising an injector housing (2) with a fuel space (4), a valve element (7) as well as a stack of piezocrystals (5) arranged in the housing within the fuel space (4) for actuating the valve element (7), a carrier element (15) disposed in the injector housing (2) and supporting the stack of piezo-crystals (5), a first seal (10) arranged so as to separate the fuel space (4) in a seal-forming fashion from a gap (24) which leads to the outside of the injector housing (2), and a further sealing element (20) arranged in the gap (24) at a distance from the first seal (10) so that a cavity (19) is formed between the first seal (10) and the further sealing element (20) and forming a space (19) for accommodating possible fuel leakage past the first seal (10).

2. The fuel injector as claimed in claim 1, wherein the first seal (10) is formed by the carrier element (15) being provided with a sealing surface (11) pressed against a sealing seat (12) which is formed on the injector housing (2).

3. The fuel injector as claimed in claim 2, wherein both, the sealing surface (11) and the sealing seat (12), are of spherical design, the sealing surface (11) on the carrier element (15) being convex and the sealing seat (12) on the injector housing (2) being concave.

4. The fuel injector as claimed in claim 2, wherein the carrier element (15) has a neck (17) which extends through a bore (14) in the injector housing (2) and electrical connecting lines (8) for energizing the piezocrystals (5) are accommodated in the neck (17) and a plug-in contact (9) is provided at an outer end of the neck (17).

5. The fuel injector as claimed in claim 4, wherein an annular gap (24) is formed between the neck (17) of the carrier element (15) and the wall of the bore (14) in the injector housing (2).

6. The fuel injector as claimed in claim 4, wherein the carrier element (15) comprises two part that is an inner element (16), which forms the neck (17), and a concentric annular element (18), on which the sealing surface (11) is formed.

7. The fuel injector as claimed in claim 2, wherein the sealing surface (11) can be lifted off from the sealing seat (12) during shutdown of the internal combustion engine and can be pressed against said sealing seat (12) before the internal combustion engine is started.

8. The fuel injector as claimed in claim 1, wherein the first seal (10) is formed by a ring consisting of one of an elastic plastic and rubber.

9. The fuel injector as claimed in claim 1, wherein a fuel leakage line (21) is connected to the annular gap (24) in the region of the cavity (19).

10. The fuel injector as claimed in claim 9, wherein the fuel leakage line (21) is exposed to ambient pressure and extends to a fuel tank (22).
